(19) United States
(12) Patent Application Publication
(10) Pub. No.: US 2019/0166042 A1
(43) Pub. Date: May 30, 2019

(54) METHOD FOR DATA TRANSMITTING, CENTRALIZED CONTROLLER, FORWARDING PLANE DEVICE AND COMMUNICATION APPARATUS

(71) Applicant: Hanqiang Hu, Guangzhou (CN)

(72) Inventor: Hanqiang Hu, Guangzhou (CN)

(21) Appl. No.: 16/262,003

(22) Filed: Jan. 30, 2019

Related U.S. Application Data
(63) Continuation of application No. PCT/CN2017/090620, filed on Jun. 28, 2017.

(30) Foreign Application Priority Data
Aug. 4, 2016 (CN) 201610641072.3
Sep. 5, 2016 (CN) 201610805051.0
Sep. 30, 2016 (CN) PCT/CN2016/101155
Apr. 25, 2017 (CN) PCT/CN2017/081924

(51) Int. Cl. H04L 12/721; H04L 12/717

(52) U.S. Cl. CPC H04L 45/34; H04L 45/42

(57) ABSTRACT

A method for data transmitting includes receiving a path establishment request from a local communication apparatus, establishing a fast transmission path between the local communication apparatus and the peer communication apparatus based on the path establishment request and sending the fast transmission path carried by a data packer to the local communication apparatus and the peer communication apparatus.

### CROSS-REFERENCE TO RELATED APPLICATIONS

The present disclosure claims priority to Chinese Patent Application No. 201610805051.0, filed with the Chinese Patent Office on Sep. 5, 2016, titled “A METHOD FOR DATA TRANSMITTING CENTRALIZED CONTROLLER, FORWARDING PLANE DEVICE AND LOCAL COMMUNICATION APPARATUS”, Chinese Patent Application No. 201610641072.3, filed with the Chinese Patent Office on Aug. 4, 2016, titled “A METHOD FOR DATA TRANSMITTING CENTRALIZED CONTROLLER, FORWARDING PLANE DEVICE AND LOCAL COMMUNICATION APPARATUS”, PCT Application No. PCT/CN2017/081924 filed with the Chinese Patent Office on Apr. 25, 2017, titled “A METHOD FOR DATA TRANSMITTING CENTRALIZED CONTROLLER, FORWARDING PLANE DEVICE AND COMMUNICATION APPARATUS” and PCT Application No. PCT/CN2016/101155 filed with the Chinese Patent Office on Aug. 30, 2016, titled “A METHOD FOR DATA TRANSMITTING CENTRALIZED CONTROLLER, FORWARDING PLANE DEVICE AND COMMUNICATION APPARATUS” the entire contents of which are incorporated herein by reference.

### TECHNICAL FIELD

The present application relates to the technical field of communications, and in particular, relate to method for data transmitting, centralized controller, forwarding plane device and communication apparatus.

### BACKGROUND

The software defined network (SDN) is an evolved network architecture of the Emulex network, and a form of network virtualization. The core technology is to separate a control plane from a data plane of a network device, such that network traffic is flexibly controlled and the network becomes more intelligent as a pipeline. In the current SDN, a centralized controller performs centralized routing calculation for all the IP data packets, and then a forwarding plane device forwards the IP data packets based on a path selected by the centralized controller, until the IP data packets are transmitted to a destination. The routing calculation needs to be performed by the centralized controller for all the IP data packets interacted between a local communication apparatus and a peer communication apparatus. Consequently, load of the centralized controller is heavy, and an end-to-end delay is increased.

### SUMMARY

An embodiment of present application provides a method for data transmitting. The method includes: receiving a path establishment request from a local communication apparatus, wherein the path establishment request carries identifiers of the local communication apparatus and a peer communication apparatus; establishing a fast transmission path between the local communication apparatus and the peer communication apparatus based on the path establishment request; and sending the fast transmission path to the local communication apparatus and the peer communication apparatus, whereby the fast transmission path is added to a data packet when the data packet is transmitted between the local communication apparatus and the peer communication apparatus, and one or a plurality of in-network forwarding plane devices forward the data packet based on the fast transmission path carried in the data packet.

Another embodiment of present application provides a method for data transmitting. The method includes: receiving a data packet transmitted in communication between a local communication apparatus and a peer communication apparatus, wherein the data packet carries a fast transmission path of communicating between the local communication apparatus and the peer communication apparatus; acquiring a next forwarding plane device based on the fast transmission path; and forwarding the data packet to the next forwarding plane device.

Another embodiment of present application provides a method for data transmitting. The method includes: receiving a fast transmission path returned from a centralized controller, wherein the fast transmission path is used to establish communication with a peer communication apparatus; adding the fast transmission path to a data packet when sending the data packet to the peer communication apparatus; and sending the data packet carrying the fast transmission path to the peer communication apparatus, through one or a plurality of forwarding plane devices determined by the fast transmission path carried in the data packet.

Still another embodiment of present application provides a method for data transmitting. The method includes: receiving a path establishment request from a communication apparatus, wherein the path establishment request carries identifiers of the communication apparatus and a peer communication apparatus; establishing a fast transmission path between the communication apparatus and the peer communication apparatus based on the path establishment request; and sending the fast transmission path to the communication apparatus, whereby the fast transmission path is added to a data packet when the data packet is transmitted between the communication apparatus and the peer communication apparatus, and one or a plurality of in-network forwarding plane devices forward the data packet based on the fast transmission path carried in the data packet.

### BRIEF DESCRIPTION OF THE DRAWINGS

For a clearer description of the technical solutions according to the embodiments of the present application, hereinafter brief description is given with reference to the accompanying drawings for illustrating the embodiments. Apparently, the accompanying drawings described hereinafter only illustrate some embodiments of the present application, and other accompanying drawings may also be derived based on these accompanying drawings.

FIG. 1 is a schematic diagram of a first transmission path in a method for data transmitting according to an embodiment of the present application;

FIG. 2 is a schematic diagram of a second transmission path in a method for data transmitting according to an embodiment of the present application;

FIG. 3 is a schematic flowchart of a method for data transmitting according to a first embodiment of the present application;

FIG. 4 is a schematic detailed flowchart of the method for data transmitting according to the first embodiment of the present application;

FIG. 5 is a schematic flowchart of a method for data transmitting according to a second embodiment of the present application;

FIG. 6 is a schematic flowchart of a method for data transmitting according to a third embodiment of the present application;

FIG. 7 is a schematic flowchart of a method for data transmitting according to a fourth embodiment of the present application;

FIG. 8 is a schematic flowchart of a method for data transmitting according to a fifth embodiment of the present application;

FIG. 9 is a schematic flowchart of a method for data transmitting according to a sixth embodiment of the present application;

FIG. 10 is a schematic detailed flowchart of a method for data transmitting according to the sixth embodiment of the present application;

FIG. 11 is a schematic detailed flowchart of a method for data transmitting according to a seventh embodiment of the present application;

FIG. 12 is a schematic detailed flowchart of a method for data transmitting according to an eighth embodiment of the present application;

FIG. 13 is a schematic detailed flowchart of a method for data transmitting according to a ninth embodiment of the present application;

FIG. 14 is a schematic diagram of a centralized controller according to a first embodiment of the present application;

FIG. 15 is a schematic diagram of a centralized controller according to a second embodiment of the present application;

FIG. 16 is a schematic diagram of a centralized controller according to a third embodiment of the present application;

FIG. 17 is a schematic diagram of a centralized controller according to a fourth embodiment of the present application;

FIG. 18 is a schematic diagram of a centralized controller according to a fifth embodiment of the present application;

FIG. 19 is a schematic diagram of a centralized controller performing a method for data transmitting according to a sixth embodiment of the present application;

FIG. 20 is a schematic diagram of a forwarding plane device according to a first embodiment of the present application;

FIG. 21 is a schematic diagram of a forwarding plane device according to a second embodiment of the present application;

FIG. 22 is a schematic diagram of a forwarding plane controller performing a method for data transmitting according to a third embodiment of the present application;

FIG. 23 is a schematic diagram of a communication apparatus according to a first embodiment of the present application;

FIG. 24 is a schematic diagram of a communication apparatus according to a second embodiment of the present application; and

FIG. 25 is a schematic diagram of a communication apparatus performing a method for data transmitting according to a third embodiment of the present application.

### DETAILED DESCRIPTION

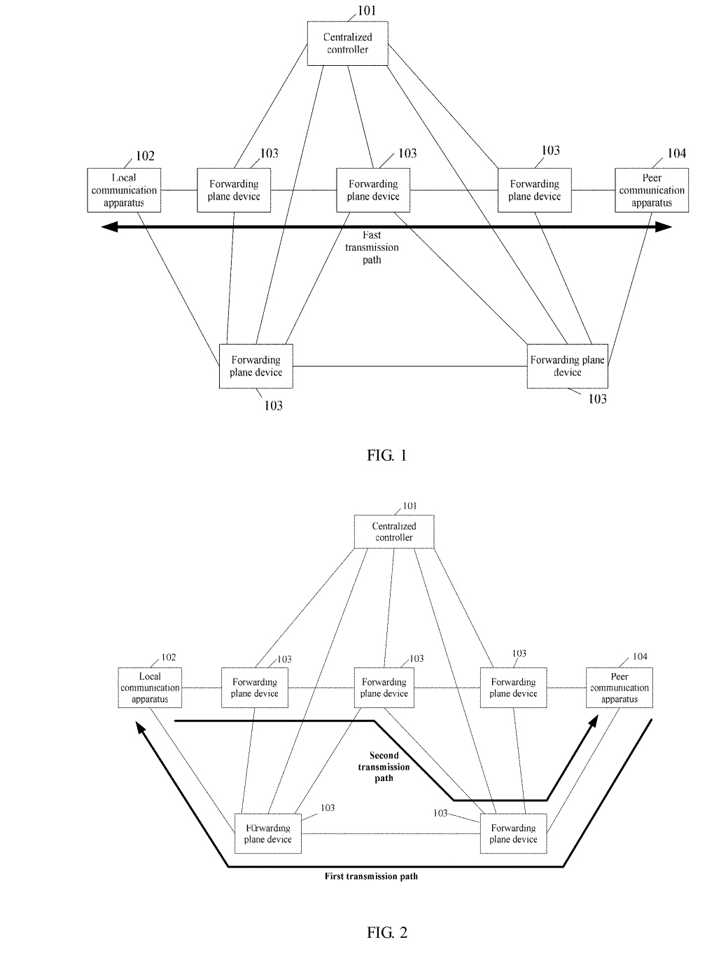

Referring to FIG. 1, a data transmission system 100 includes a centralized controller 101, a local communication apparatus 102, a plurality of forwarding plane devices 103 and a peer communication apparatus 104. When the local communication apparatus 102 sends a path establishment request to the peer communication apparatus 104, the path establishment request is firstly sent to the centralized controller 101. The centralized controller 101 identifies that the request is a fast transmission path establishment request, establishes a fast transmission path between the local communication apparatus 102 and the peer communication apparatus 104 based on the path establishment request, and sends the fast transmission path to the local communication apparatus 102 and the communication apparatus 104, such that when a data packet is transmitted between the local communication apparatus 102 and the communication apparatus 104, the fast transmission path is added to the data packet, and one or a plurality of forwarding plane device 103 forwards the data packet based on the fast transmission path carried in the data packet. It should be noted that the forwarding plane device 103 may be a physical forwarding plane device or may be a virtual forwarding plane device, for example, a virtual switch device; and two or more virtual forwarding plane devices 103 illustrated in FIG. 1 may be configured in the same physical forwarding plane device.

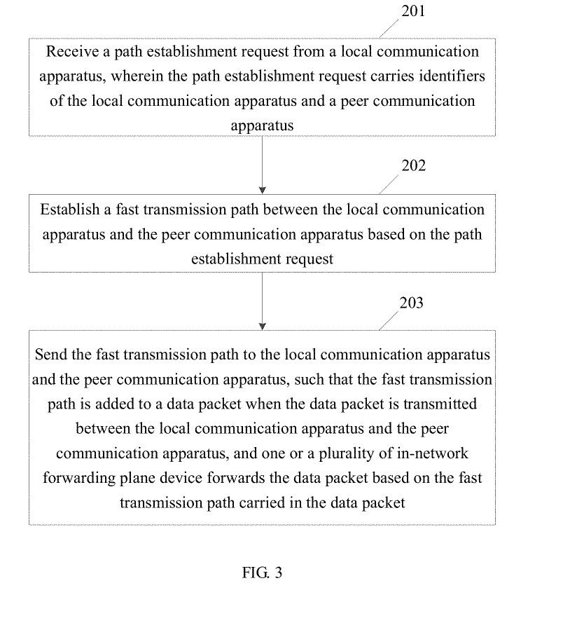

A path from the local communication apparatus 102 to the peer communication apparatus 104 may be different from the fast transmission path from the peer communication apparatus 104 to the local communication apparatus 102. Referring to FIG. 2, the fast transmission path includes a first transmission path and a second transmission path, wherein the first transmission path is a path from the peer communication apparatus 104 to the local communication apparatus 102, and the second transmission path is a path from the local communication apparatus 102 to the peer communication apparatus 104; and the data packet includes a first transmission packet and a second transmission packet, wherein the first transmission packet is a data packet sent from the peer communication apparatus 104 to the local communication apparatus 102, and the second transmission packet is a data packet sent from the local communication apparatus 102 to the peer communication apparatus 104. The step of sending a fast transmission path to the local communication apparatus 102 and the peer communication apparatus 104 includes: adding the first transmission path to the path establishment request, and sending the path establishment request carrying the first transmission path to the peer communication apparatus 104; receiving a response message indicating that the peer communication apparatus agrees to establish the fast transmission path, wherein when the peer communication apparatus 104 sends the first transmission packet to the local communication apparatus 102, the first transmission path is added to the first transmission packet, such that the in-network forwarding plane device 103 receiving the first transmission packet forwards the first transmission packet based on the first transmission path carried in the first transmission packet; adding the second transmission path to the response message, and forwarding the response message carrying the second transmission path to the local communication apparatus 102, such that when the local communication apparatus 102 sends the second transmission packet to the peer communication apparatus 104, the second transmission path is added to the second transmission packet, and the in-network forwarding plane device receiving the second transmission packet forwards the second transmission packets based on the second transmission path carried in the second transmission packet.

In an SDN network, data is transmitted over the fast transmission path established between the local communication apparatus and the peer communication apparatus; after the fast transmission path is added to the data packet, the in-network forwarding plane device directly and quickly forwards the data packet based on the fast transmission path carried in the data packet upon receiving the data packet, with no need to request a forwarding route from the centralized controller during forwarding the data packet. This greatly reduces the load of the centralized controller, improves the speed at which the forwarding plane device forwards the data packet, and enhances the transmission capability of the network.

It should be noted that in some conventional method for data transmitting, an access switch firstly receives a path delivered by the centralized controller; after a data packet is received from end point, a path is acquired by querying a routing table and attached to the data packet. Finally, the data packet carrying the path is forwarded. Compared with the conventional method for data transmitting, the embodiment of the present application achieves the following beneficial distinguishing features: First, prior to sending the data packet, the local communication apparatus or the peer communication apparatus firstly directly selects a correct access device, a virtual access device or a first forwarding plane device based on the path delivered by the centralized controller, and then attaches the path to the data packet and sends the data packet to the corresponding access device, virtual access device or forwarding plane device, such that the data packet is forwarded by the corresponding access device, virtual access device or forwarding plane device. Second, since entries in the routing table are generally huge, each time when the data packet is received, the path is selected from the routing table, which greatly increases a network delay. However, according to the embodiment of the present application, the path may be acquired with no need of querying the routing table, which prevents the network delay caused thereby. Third, according to the embodiment of the present application, since there is no need to receive the path delivered by the centralized controller, the following problems are avoided: The routing entries of the access switch are difficult to maintain; when the terminal moves, the corresponding entries in the original access switch need to be deleted and new entries need to be added in a new access switch, which may a cause a heavy load to the system operation and failures to update the entries sometimes; and in addition, the access switch needs to reserve a huge space for the entries, which may cause a high cost but a low performance to the system.

Referring to FIG. 3, FIG. 3 is a flowchart of a method for data transmitting according to a first embodiment of the present application. The method for data transmitting includes the following steps:

Step 201: A path establishment request is received from a local communication apparatus, wherein the path establishment request carries identifiers of the local communication apparatus and a peer communication apparatus.

The local communication apparatus and the peer communication apparatus are two end points in communication. The identifier of the local communication apparatus is a mark of the local communication apparatus, and the identifier of the peer communication apparatus is a mark of the peer communication apparatus. The identifiers of the local communication apparatus and the peer communication apparatus are both unique. The marker may be an ID or an IP address. It should be noted that the path establishment request may be an IP packet sent from the local communication apparatus to the peer communication apparatus. The IP packet carries the identifiers of the local communication apparatus and the peer communication apparatus. Upon receiving the IP packet, a centralized controller establishes a fast transmission path by identifying the identifiers of the local communication apparatus and the peer communication apparatus.

Step 202: A fast transmission path is established between the local communication apparatus and the peer communication apparatus based on the path establishment request.

A centralized routing table records routing information of various in-network forwarding plane devices. Therefore, the fast transmission path may be established between the local communication apparatus and the peer communication apparatus based on the centralized routing table. It should be noted that if the local communication apparatus and the peer communication apparatus are not located in the same domain, during establishment of the fast transmission path, the fast transmission path is established based on two centralized routing tables of two centralized controller in the domains where the local communication apparatus and the peer communication apparatus are located; and if the local communication apparatus and the peer communication apparatus are located in the same domain, the fast transmission path is directly established based on a routing table of a centralized controller in the domain.

Step 203: The fast transmission path is sent to the local communication apparatus and the peer communication apparatus, such that the fast transmission path is added to a data packet when the data packet is transmitted between the local communication apparatus and the peer communication apparatus, and one or a plurality of forwarding plane device forward the data packet based on the fast transmission path carried in the data packet.

After the fast transmission path is added to the data packet, the in-network forwarding plane device directly and quickly forwards the data packet based on the fast transmission path carried in the data packet upon receiving the data packet, with no need to request a forwarding route from the centralized controller during forwarding the data packet. This greatly reduces the load of the centralized controller, improves the speed at which the forwarding plane device forwards the data packet, and enhances the transmission capability of the network. It should be noted that the in-network forwarding plane device refers to a forwarding plane device between the peer communication apparatus and the local communication apparatus. The in-network forwarding plane device may be a physical forwarding plane device or a virtual forwarding plane device, for example, a virtual switch device; and two or more virtual forwarding plane devices illustrated in FIG. 1 may be configured in the same physical forwarding plane device.

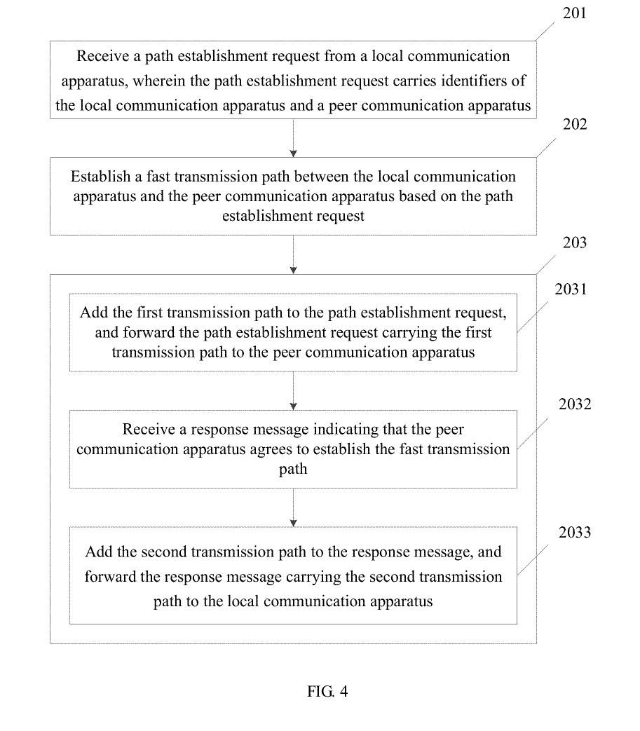

Further, one or a plurality of fast transmission paths may be established between the local communication apparatus and the peer communication apparatus. When a plurality of fast transmission paths are established between the local communication apparatus and the peer communication apparatus, the plurality of fast transmission paths may be alternately used, and thus the transmission speed may be improved. If one fast transmission path is faulty, any of the other fast transmission paths may be called for data transmission, which creates great convenience. The plurality of fast transmission paths may also be ranked. A path with a higher ranking is firstly used for data transmission. When the path with the higher ranking is faulty, a path ranked below the faulty path is used for data transmission, and so on. In another alternative embodiment, the fast transmission path over which the peer communication apparatus sends data to the local communication apparatus may be different from the fast transmission path over which the local communication apparatus sends data to the peer communication apparatus. In this case, the fast transmission path includes a first transmission path and a second transmission path, wherein the first transmission path is a path from the peer communication apparatus to the local communication apparatus, and the second transmission path is a path from the local communication apparatus to the peer communication apparatus. The data packet includes a first transmission packet and a second transmission packet, wherein the first transmission packet is a data packet sent from the peer communication apparatus to the local communication apparatus, and the second transmission packet is a data packet sent from the local communication apparatus to the peer communication apparatus. In this case, referring to FIG. 4, step 203 includes the following steps:

Step 2031: The first transmission path is added to the path establishment request, and the path establishment request carrying the first transmission path is forwarded to the peer communication apparatus; and the peer communication apparatus stores the first transmission path upon receiving the path establishment request carrying the first transmission path.

Step 2032: A response message indicating that the peer communication apparatus agrees to establish the fast transmission path is received, wherein when the peer communication apparatus sends the first transmission packet to the local communication apparatus, the first transmission path may also be added to the first transmission packet, such that the in-network forwarding plane device receiving the first transmission packet forwards the first transmission packet based on the first transmission path carried in the first transmission packet; and the response message indicating that peer communication apparatus agrees to establish the fast transmission path means that the peer communication apparatus agrees to establish the fast transmission path with the local communication apparatus, and the first transmission path is added to a first data packet when the peer communication apparatus subsequently sends the first data packet to the local communication apparatus.

Step 2033: The second transmission path is added to the response message, and the response message carrying the second transmission path is forwarded to the local communication apparatus, such that when the local communication apparatus sends the second transmission packet to the peer communication apparatus, the second transmission path is added to the second transmission packet, and the in-network forwarding plane receiving the second transmission packet forwards the second transmission packet based on the second transmission path carried in the second transmission packet.

The response message includes the second transmission path. After the second transmission path is added to the response message, the response message is forwarded to the local communication apparatus. In this way, the local communication apparatus also records the second transmission path, and the second transmission path is added to a second data packet when the local communication subsequently sends the second data packet to the peer communication apparatus.

It should be noted that the execution subject of the method for data transmitting provided in steps 201 to 203 in the embodiment of the present application may be a centralized controller. In the embodiment of the present application, the fast transmission between the local communication apparatus and the peer communication apparatus is established, and when the data packet is transmitted between the peer communication apparatus and the local communication apparatus, the fast transmission path is added to the data packet, such that the in-network forwarding plane device directly and quickly forwards the data packet based on the fast transmission path carried in the data packet upon receiving the data packet, with no need to request a forwarding route from the centralized controller during forwarding the data packet. This greatly reduces the load of the centralized controller, improves the speed at which the forwarding plane device forwards the data packet, and enhances the transmission capability of the network.

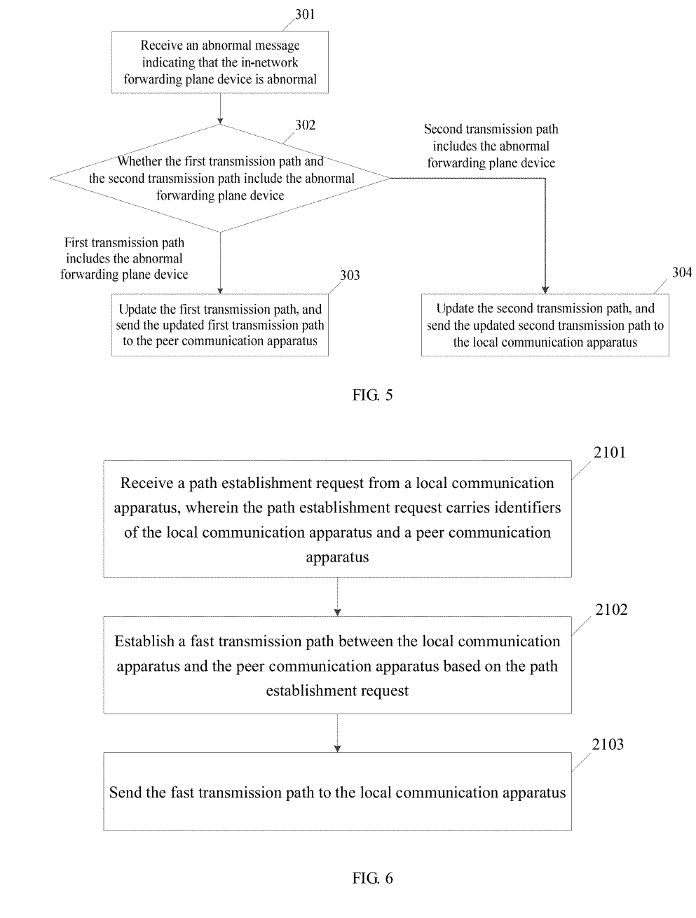

Referring to FIG. 5, FIG. 5 is a schematic flowchart of a method for data transmitting according to a second embodiment of the present application. The second embodiment is different from the first embodiment in that the method for data transmitting according to the second embodiment further includes the following steps:

Step 301: An abnormal message indicating that the in-network forwarding plane device is abnormal is received, wherein the abnormal message carries an identifier of the abnormal forwarding plane device. The identifier of the forwarding plane device is a unique mark of the forwarding plane device.

Step 302: Whether the first transmission path and the second transmission path include the abnormal forwarding plane device is judged. If the first transmission path includes the abnormal forwarding plane device, it indicates that the first transmission path has a break point and the first transmission path may not be communicated. Likewise, if the second transmission path includes the abnormal forwarding plane device, it indicates that the second transmission path has a break point, the second transmission path may not be communicated, and the first transmission path and the second transmission path both need to be updated.

Step 303: If the first transmission path includes the abnormal forwarding plane device, the first transmission path is updated, and the updated first transmission path is sent to the peer communication apparatus. Updating the first transmission path refers to re-establishing the first transmission path, such that the first transmission path does not include the abnormal forwarding plane device, and the updated first transmission path is communicable.

Step 304: If the second transmission path includes the abnormal forwarding plane device, the second transmission path is updated, and the updated second transmission path is sent to the local communication apparatus. Updating the second transmission path refers to re-establishing the second transmission path, such that the second transmission path does not include the abnormal forwarding plane device, and the updated second transmission path is communicable.

It should be noted that the execution subject of the method for data transmitting provided in steps 301 to 304 in the embodiment of the present application may be a centralized controller. In the embodiment of the present application, when the in-network forwarding plane device is abnormal, and the transmission path includes the abnormal forwarding plane device, the transmission path of the abnormal forwarding plane device is updated and sent to the corresponding communication end, such that the communication end sends the transmission packet over the communicable transmission path. This prevents transmission packet loss when an incommunicable transmission path is used.

Referring to FIG. 6, FIG. 6 is a flowchart of a method for data transmitting according to a third embodiment of the present application. The method for data transmitting includes the following steps:

Step 2101: A path establishment request is received from a local communication apparatus, wherein the path establishment request carries identifiers of the local communication apparatus and a peer communication apparatus.

Step 2102: A fast transmission path is established between the local communication apparatus and the peer communication apparatus based on the path establishment request.

Step 2103: The fast transmission path is sent to the local communication apparatus, such that the fast transmission path is added to a data packet when the local communication apparatus transmits a data packet to the peer communication apparatus, and one or a plurality of forwarding plane device forwards the data packet based on the fast transmission path carried in the data packet.

It should be noted that the execution subject of the method for data transmitting provided in steps 2101 to 2103 in the embodiment of the present application may be a centralized controller.

In the embodiment of the present application, the fast transmission between the local communication apparatus and the peer communication apparatus is established, and when the data packet is transmitted from the peer communication apparatus to the local communication apparatus, the fast transmission path is added to the data packet, such that the in-network forwarding plane device directly and quickly forwards the data packet based on the fast transmission path carried in the data packet upon receiving the data packet, with no need to request a forwarding route from the centralized controller during forwarding the data packet. This greatly reduces the load of the centralized controller, improves the speed at which the forwarding plane device forwards the data packet, and enhances the transmission capability of the network.

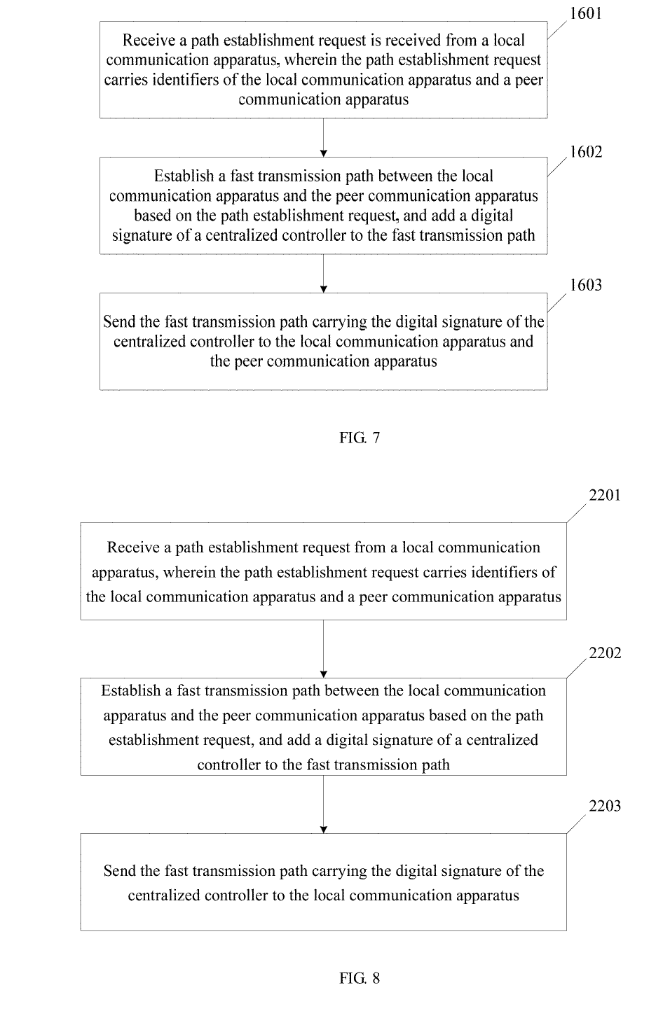

Referring to FIG. 7, FIG. 7 is a flowchart of a method for data transmitting according to a fourth embodiment of the present application. The method for data transmitting includes the following steps:

Step 1601: A path establishment request is received from a local communication apparatus, wherein the path establishment request carries identifiers of the local communication apparatus and a peer communication apparatus. The local communication apparatus and the peer communication apparatus are two ends between which communication is carried out. The identifier of the local communication apparatus is a mark of the local communication apparatus, the identifier of the peer communication apparatus is a mark of the peer communication apparatus, and the identifiers of the local communication apparatus and the peer communication apparatus are both unique. The marker may be an ID or an IP address. It should be noted that the path establishment request may be an IP packet sent from the local communication apparatus to the peer communication apparatus. The IP packet carries the identifiers of the local communication apparatus and the peer communication apparatus. Upon receiving the IP packet, a centralized controller establishes a fast transmission path by identifying the identifiers of the local communication apparatus and the peer communication apparatus.

Step 1602: A fast transmission path is established between the local communication apparatus and the peer communication apparatus based on the path establishment request, and a digital signature of a centralized controller is added to the fast transmission path. A centralized routing table records routing information of various in-network forwarding plane devices. Therefore, the fast transmission path may be established between the local communication apparatus and the peer communication apparatus based on the centralized routing table. It should be noted that if the local communication apparatus and the peer communication apparatus are not located in the same domain, during establishment of the fast transmission path, the fast transmission path is established based on two centralized routing tables of two centralized controller in the domains where the local communication apparatus and the peer communication apparatus are located; and if the local communication apparatus and the peer communication apparatus are located in the same domain, the fast transmission path is directly established based on a routing table of a centralized controller in the domain.

A digital signature of a unique corresponding centralized controller is added to each newly established fast transmission path. The digital signature is a digit string that may be only generated by the information sender and may not be counterfeited by others. The digit string is also a valid certificate of authenticity of the information sent by the information sender. The digital signature of the centralized controller may be added by using an algorithm such as RSA, ELGamal, DSA or the like. By the digital signature technology, abstract information is encrypted by a private key of a sender, and sent to a receiver together with the original text; the encrypted abstract information may be only decrypted by the receiver using a public key of the sender; and a piece of abstract information is generated from the received original text by using the HASH function and compared with the decrypted abstract information. If the abstract information is the same, the received information is complete and not modified during transmission; and otherwise, the information has been modified. Therefore, the digital signature may be used to verify completeness of the information. The digital signature is an encryption process, and the digital signature-based verification is a decryption process. The digital signature of the centralized controller is added to the fast transmission path and the data packet is sent based on the fast transmission path after the communication terminals and the forwarding plane device verify the digital signature of the centralized controller. In this way, transmission of the data packet over the counterfeited fast transmission path may be prevented when a hacker counterfeits the fast transmission path and sends the counterfeited fast transmission path to the communication terminals and the forwarding plane device, active-defense capabilities of the SDN against the hacker may be enhanced, and the security of the SDN may be improved.

Step 1603: The fast transmission path carrying the digital signature of the centralized controller is sent to the local communication apparatus and the peer communication apparatus, such that when a data packet is transmitted between the local communication apparatus and the peer communication apparatus and after the fast transmission path is verified to be correct based on the digital signature of the centralized controller, the fast transmission path carrying the digital signature of the centralized controller is added to the data packet, and one or a plurality of forwarding plane device forwards the data packet based on the fast transmission path after the fast transmission path is verified to be correct based on the digital signature of the centralized controller.

The fast transmission path carrying the digital signature of the centralized controller is sent to the local communication apparatus and the peer communication apparatus, such that before the data packet is transmitted between the local communication apparatus and the peer communication apparatus, the fast transmission path is firstly verified based on the digital signature of the centralized controller, when the fast transmission path is verified to be correct, the fast transmission path carrying the digital signature of the centralized controller is added to the data packet, and one or a plurality of forwarding plane device forwards the data packet based on the fast transmission path after the fast transmission path is verified to be correct based on the digital signature of the centralized controller.

It should be noted that the execution subject of the method for data transmitting provided in steps 1601 to 1603 in the embodiment of the present application may be a centralized controller.

In the embodiment of the present application, the fast transmission path is established between the peer communication apparatus and the local communication apparatus, and the digital signature of the centralized controller is added to the fast transmission path, such that when the data packet is transmitted between the peer communication apparatus and the local communication apparatus and after the fast transmission path is verified to be correct based on the digital signature of the centralized controller, the fast transmission path carrying the digital signature of the centralized controller is added to the data packet, and the in-network forwarding plane device forwards the data packet after the fast transmission path is verified to be corrected based on the digital signature of the centralized controller, with no need to request a forwarding route from the centralized controller during forwarding the data packet. This greatly reduces the load of the centralized controller, improves the speed at which the forwarding plane device forwards the data packet, and enhances the transmission capability of the network. In addition, since the digital signature of the centralized controller is added to the fast transmission path, after the fast transmission path is verified to be correct based on the digital signature of the centralized controller, and the data packet is forwarded based on the fast transmission path, the fast transmission path is ensured to be correct, communication security of the network is ensured, and hackers are prevented from controlling the network over an unauthorized path.

Referring to FIG. 8, FIG. 8 is a flowchart of a method for data transmitting according to a fifth embodiment of the present application. The method for data transmitting includes the following steps:

Step 2201: A path establishment request is received from a local communication apparatus, wherein the path establishment request carries identifiers of the local communication apparatus and a peer communication apparatus.

Step 2202: A fast transmission path is established between the local communication apparatus and the peer communication apparatus based on the path establishment request, and a digital signature of a centralized controller is added to the fast transmission path.

Step 2203: The fast transmission path carrying the digital signature of the centralized controller is sent to the local communication apparatus, such that when the local communication apparatus transmits a data packet to the peer communication apparatus and after the fast transmission path is verified to be correct based on the digital signature of the centralized controller, the fast transmission path carrying the digital signature of the centralized controller is added to the data packet, and one or a plurality of forwarding plane device forwards the data packet based on the fast transmission path after the fast transmission path is verified to be correct based on the digital signature of the centralized controller.

It should be noted that the execution subject of the method for data transmitting provided in steps 2201 to 2203 in the embodiment of the present application may be a centralized controller.

In the embodiment of the present application, the fast transmission path is established between the peer communication apparatus and the local communication apparatus, and the digital signature of the centralized controller is added to the fast transmission path, such that when the local communication apparatus transmits the data packet to the local communication apparatus and after the fast transmission path is verified to be correct based on the digital signature of the centralized controller, the fast transmission path carrying the digital signature of the centralized controller is added to the data packet, and the in-network forwarding plane device forwards the data packet after the fast transmission path is verified to be corrected based on the digital signature of the centralized controller, with no need to request a forwarding route from the centralized controller during forwarding the data packet. This greatly reduces the load of the centralized controller, improves the speed at which the forwarding plane device forwards the data packet, and enhances the transmission capability of the network. In addition, since the digital signature of the centralized controller is added to the fast transmission path, after the fast transmission path is verified to be correct based on the digital signature of the centralized controller, and the data packet is forwarded based on the fast transmission path, the fast transmission path is ensured to be correct, communication security of the network is ensured, and hackers are prevented from controlling the network over an unauthorized path.

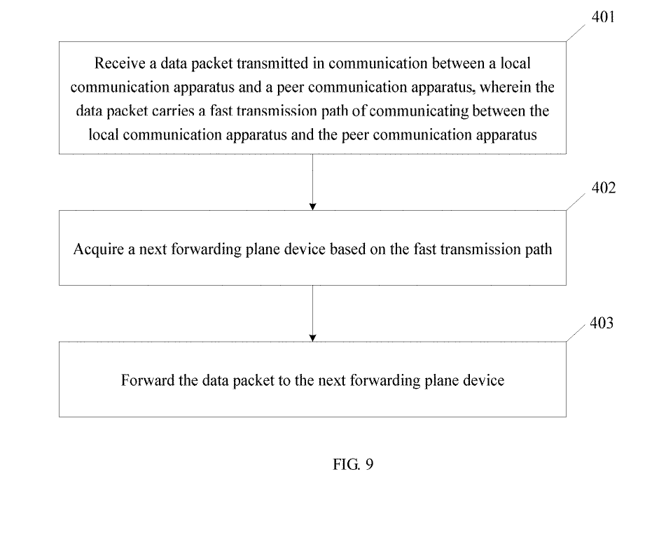

Referring to FIG. 9, FIG. 9 is a flowchart of a method for data transmitting according to a sixth embodiment of the present application. The method for data transmitting includes the following steps:

Step 401: A data packet transmitted in communication between a local communication apparatus and a peer communication apparatus is received, wherein the data packet carries a fast transmission path for the communication between the local communication apparatus and the peer communication apparatus. The fast transmission path records paths for data packet transmission between the local communication apparatus and the peer communication apparatus.

Step 402: A next forwarding plane device is acquired based on the fast transmission path.

The path carried in the fast transmission path indicates a direction. Therefore, upon receiving the data packet and extracting the fast transmission path from the data packet, the forwarding plane device may determine its location in the fast transmission path, and acquire the next forwarding plane device based on the direction of the path.

Step 403: The data packet is forwarded to the next forwarding plane device.

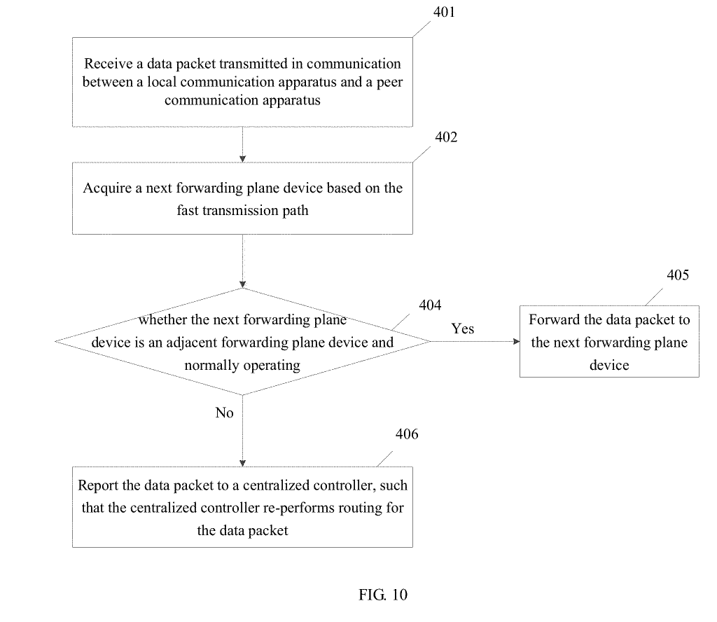

After a next node is acquired, the data packet is forwarded to the next node, then a further next node is acquired and the data is forwarded to the further next node until the data packet is forwarded to a destination. Further, before the data packet is forwarded to the next forwarding device, whether the next forwarding plane device is normal may be judged. If the next forwarding plane device is incorrect, a new fast transmission path is requested from a centralized controller. This prevents the data packet from being sent to the abnormal forwarding plane device and thus avoids data packet loss. Specifically, referring to FIG. 10, the process includes the following steps:

Step 404: Whether the next forwarding plane device is an adjacent forwarding plane device and whether the next forwarding plane device is normally operating are judged. If the next forwarding plane device is an adjacent forwarding plane device and the next forwarding plane device is normally operating, step 405 is performed; and otherwise, step 406 is performed. Whether the location of one or a plurality of forwarding plane device is changed is judged by judging whether the next forwarding plane device is an adjacent forwarding plane device.

Step 405: The data packet is forwarded to the next forwarding plane device. If the next forwarding plane device is not an adjacent forwarding plane device, the location of the in-network forwarding plane device is changed, and the fast transmission path also needs to be synchronously updated.

Step 406: The data packet is reported to a centralized controller, such that the centralized controller re-performs routing for the data packet.

It should be noted that the execution subject of the method for data transmitting provided in steps 401 to 406 in the embodiment of the present application may be a forwarding plane device. In the embodiment of the present application, the fast transmission between the local communication apparatus and the peer communication apparatus is established, and when the data packet is transmitted between the peer communication apparatus and the local communication apparatus, the fast transmission path is added to the data packet, such that the in-network forwarding plane device directly and quickly forwards the data packet based on the fast transmission path carried in the data packet upon receiving the data packet, with no need to request a forwarding route from the centralized controller during forwarding the data packet. This greatly reduces the load of the centralized controller, improves the speed at which the forwarding plane device forwards the data packet, and enhances the transmission capability of the network.

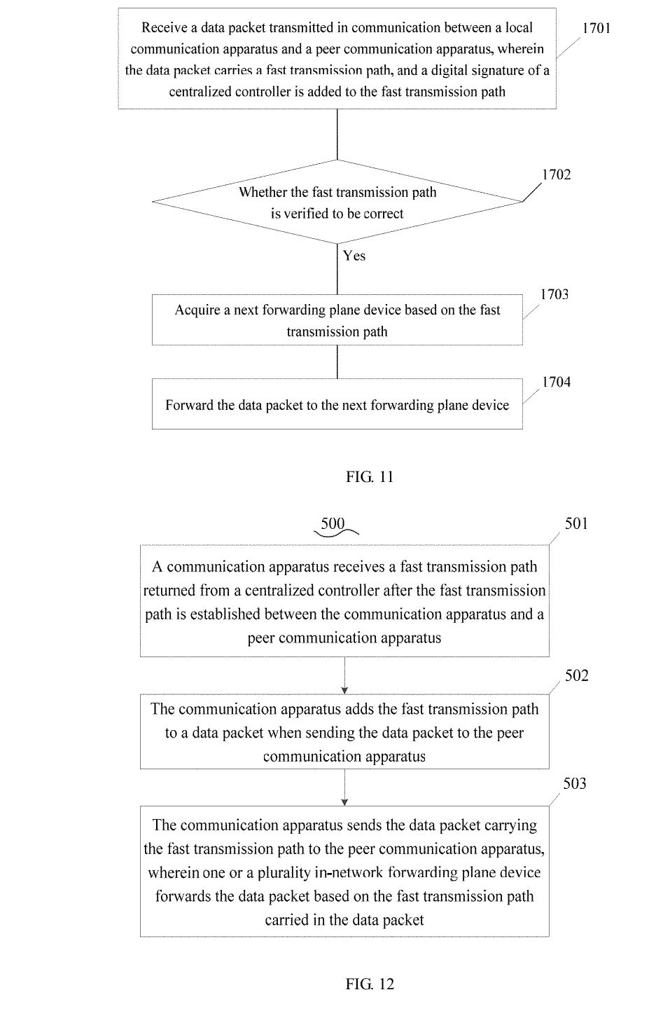

Referring to FIG. 11, FIG. 11 is a flowchart of a method for data transmitting according to a seventh embodiment of the present application. The method for data transmitting includes the following steps:

Step 1701: A data packet transmitted in communication between a local communication apparatus and a peer communication apparatus is received, wherein the data packet carries a fast transmission path for the communication between the local communication apparatus and the peer communication apparatus. A digital signature of a centralized controller is added to the fast transmission path. The fast transmission path records paths for data packet transmission between the local communication apparatus and the peer communication apparatus, and the fast transmission path carries the digital signature of the centralized controller.

Step 1702: The fast transmission path is verified based on the digital signature of the centralized controller.

Completeness and validity of the fast transmission path are verified based on the digital signature of the centralized controller.

Since the transmission path carried in the data packet transmitted in the communication between the local communication apparatus and the peer communication apparatus may be a false transmission path counterfeited by a hacker or an incomplete transmission path modified by the hacker, the validity and completeness of the transmission path need to be verified. By the digital signature technology, abstract information is encrypted by a private key of a sender, and sent to a receiver together with the original text; the encrypted abstract information may be only decrypted by the receiver using a public key of the sender; and a piece of abstract information is generated from the received original text by using the HASH function and compared with the decrypted abstract information. If the abstract information is the same, the received information is complete and not modified during transmission; and otherwise, the information has been modified. Therefore, the digital signature may be used to verify the completeness of the fast transmission path.

Further, the digital signature allows an information receiver to confirm the identification of an information sender. Nevertheless, the information receiver may not one hundred percent confirm the real identification of the information sender, but may confirm the real identification of the information sender where the password system is not cracked. Therefore, when the password system is not cracked, the establisher or sender who establishes or sends the fast transmission path may be determined based on the digital signature, such that the validity of the fast transmission path is verified. When it is verified based on the digital signature that the fast transmission path has both completeness and validity, it is considered that the fast transmission path is verified to be correct, and a next step is performed; and otherwise, the data packet is not forwarded.

Step 1703: A next forwarding plane device is acquired based on the fast transmission path if the fast transmission path is verified to be correct.

The path carried in the fast transmission path indicates a direction. Therefore, upon receiving the data packet and extracting the fast transmission path from the data packet, the forwarding plane device may determine its location in the fast transmission path, and acquire the next forwarding plane device based on the direction of the path.

Step 1704: The data packet is forwarded to the next forwarding plane device.

After a next node is acquired, the data packet is forwarded to the next node, then a further next node is acquired and the data is forwarded to the further next node until the data packet is forwarded to a destination.

It should be noted that the execution subject of the method for data transmitting provided in steps 1701 to 1704 in the embodiment of the present application may be a forwarding plane device. In the embodiment of the present application, the fast transmission path is established between the peer communication apparatus and the local communication apparatus, and the digital signature of the centralized controller is added to the fast transmission path, such that when the data packet is transmitted between the peer communication apparatus and the local communication apparatus and after the fast transmission path is verified to be correct based on the digital signature of the centralized controller, the fast transmission path carrying the digital signature of the centralized controller is added to the data packet, and the in-network forwarding plane device forwards the data packet after the fast transmission path is verified to be corrected based on the digital signature of the centralized controller, with no need to request a forwarding route from the centralized controller during forwarding the data packet. This greatly reduces the load of the centralized controller, improves the speed at which the forwarding plane device forwards the data packet, and enhances the transmission capability of the network. In addition, since the digital signature of the centralized controller is added to the fast transmission path, after the fast transmission path is verified to be correct based on the digital signature of the centralized controller, and the data packet is forwarded based on the fast transmission path, the fast transmission path is ensured to be correct, communication security of the network is ensured, and hackers are prevented from controlling the network over an unauthorized path.

Referring to FIG. 12, FIG. 12 is a schematic flowchart of a method for data transmitting according to an eighth embodiment of the present application. Step 501: A communication apparatus receives a fast transmission path returned from a centralized controller after the fast transmission path is established between the communication apparatus and a peer communication apparatus.

The communication apparatus may be a local end that initiates the path establishment request, or may be a peer end opposite to the local end. When the communication apparatus is a local end, the communication apparatus further sends the path establishment request to the centralized controller. Upon receiving the path establishment request, the centralized controller establishes the fast transmission path based on a centralized routing table, and returns the fast transmission path to the communication apparatus and the peer communication apparatus; when the communication apparatus is a peer end, the peer communication apparatus receives the fast transmission path returned by the centralized controller. Nevertheless, in another alternative embodiment, the path establishment request may also be initiated by another device besides the local end and the peer end. Alternatively, the path establishment request is an IP packet transmitted between the local end and the peer end, and the fast transmission path is established based on the IP packet transmitted between the local end and the peer end.

Step 502: The communication apparatus adds the fast transmission path to a data packet when sending the data packet to the peer communication apparatus.

After the fast transmission path is added to the data packet, one or a plurality of forwarding plane device directly and quickly forwards the data packet based on the fast transmission path carried in the data packet upon receiving the data packet, with no need to request a forwarding route from the centralized controller during forwarding the data packet. This greatly reduces the load of the centralized controller.

Step 503: The communication apparatus sends the data packet carrying the fast transmission path to the peer communication apparatus, wherein one or a plurality of forwarding plane device forwards the data packet based on the fast transmission path carried in the data packet.

Specifically, the communication apparatus selects a first forwarding plane device based on the fast transmission path, determines the first forwarding plane device as an access device or a virtual access device, and sends the data packet carrying the fast transmission path to the first forwarding plane device, such that the first forwarding plane device forwards the data packet based on the fast transmission path carried in the data packet, and another in-network forwarding plane device forwards the data packet based on the fast transmission path carried in the data packet until the data packet is sent to the peer communication apparatus. One or a plurality of in-network forwarding plane devices may be configured.

Upon receiving the data packet, the in-network forwarding plane device directly and quickly forwards the data packet based on the fast transmission path carried in the data packet, with no need to request a forwarding route from the centralized controller during forwarding the data packet. This improves the speed at which the forwarding plane device forwards the data packet, and enhances the transmission capability of the network. It should be noted that the in-network forwarding plane device refers to a forwarding plane device between the peer communication apparatus and the communication apparatus.

It should be noted that the execution subject of the method for data transmitting provided in steps 501 to 503 in the embodiment of the present application may be a communication apparatus. In the embodiment of the present application, the communication apparatus sends a path request to the centralized controller, and the centralized controller establishes the fast transmission path and sends the established fast transmission path to the communication apparatus. In this way, when the communication apparatus sends the data packet carrying the fast transmission path, there is no need to further calculate and find the path by the centralized controller, and the data packet is directly and quickly forwarded based on the fast transmission path carried in the data packet. As such, the in-network forwarding plane device does not need to request the forwarding route from the centralized controller. This greatly reduces the load of the centralized controller, improves the speed at which the forwarding plane device forwards the data packet, and enhances the transmission capability of the network.

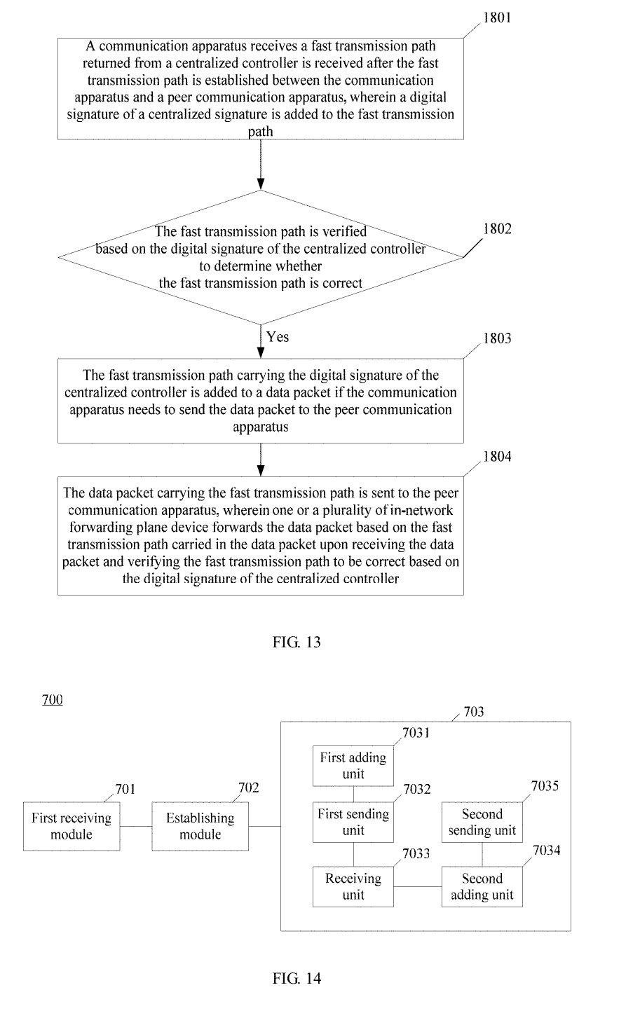

Referring to FIG. 13, FIG. 13 is a flowchart of a method for data transmitting according to a ninth embodiment of the present application. The method for data transmitting includes the following steps:

Step 1801: A communication apparatus receives a fast transmission path returned from a centralized controller after the fast transmission path is established between the communication apparatus and a peer communication apparatus, wherein a digital signature of a centralized signature is added to the fast transmission path.

The communication apparatus may be a local end that initiates the path establishment request, or may be a peer end opposite to the local end. When the communication apparatus is a local end, the communication apparatus further sends the path establishment request to a centralized controller. Upon receiving the path establishment request, the centralized controller establishes the fast transmission path based on a centralized routing table, and returns the fast transmission path to the communication apparatus and the peer communication apparatus; when the communication apparatus is a peer end, the peer communication apparatus receives the fast transmission path returned by the centralized controller. Nevertheless, in another alternative embodiment, the path establishment request may also be initiated by another device besides the local end and the peer end. Alternatively, the path establishment request is an IP packet transmitted between the local end and the peer end, and the fast transmission path is established based on the IP packet transmitted between the local end and the peer end, wherein the fast transmission path carries the digital signature of the centralized controller.

Step 1802: The fast transmission path is verified based on the digital signature of the centralized controller. Since the transmission path received by the communication apparatus may be a false transmission path counterfeited by a hacker or an incomplete transmission path modified by the hacker, the validity and completeness of the transmission path need to be verified. The verification method is the same as that in step 1702 in the seventh embodiment of the method for data transmitting, which is not described herein any further.

Step 1803: The fast transmission path carrying the digital signature of the centralized controller is added to a data packet if the fast transmission path is verified to be correct and the communication apparatus needs to send the data packet to the peer communication apparatus.

After the fast transmission path carrying the digital signature of the centralized controller is added to the data packet, when the fast transmission path is verified to be correct and one or a plurality of forwarding plane device receives the data packet, the in-network forwarding plane device directly and quickly forwards the data packet based on the fast transmission path carried in the data packet, with no need to request a forwarding route from the centralized controller during forwarding the data packet. This greatly reduces the load of the centralized controller.

Step 1804: The data packet carrying the fast transmission path is sent to the peer communication apparatus, wherein one or a plurality of forwarding plane device forwards the data packet based on the fast transmission path carried in the data packet upon receiving the data packet and verifying the fast transmission path to be correct based on the digital signature of the centralized controller.

Specifically, the communication apparatus selects a first forwarding plane device based on the fast transmission path, determines the first forwarding plane device as an access device or a virtual access device, and sends the data packet carrying the fast transmission path to the first forwarding plane device, such that the first forwarding plane device forwards the data packet based on the fast transmission path carried in the data packet upon receiving the data packet and verifying the fast transmission path to be correct based on the digital signature of the centralized controller, and another in-network forwarding plane device also forwards the data packet based on the fast transmission path carried in the data packet upon receiving the data packet and verifying the fast transmission path to be correct based on the digital signature of the centralized controller, until the data packet is forwarded to the peer communication apparatus. One or a plurality of in-network forwarding plane devices may be configured.

Upon receiving the data packet and verifying the fast transmission path to be correct, the in-network forwarding plane device directly and quickly forwards the data packet based on the fast transmission path carried in the data packet, with no need to request a forward routing from the centralized controller during forwarding the data packet. This improves the speed at which the forwarding plane device forwards the data packet, and enhances the transmission capability of the network. It should be noted that the in-network forwarding plane device refers to a forwarding plane device between the peer communication apparatus and the communication apparatus.

It should be noted that the execution subject of the method for data transmitting provided in steps 1801 to 1804 in the embodiment of the present application may be a communication apparatus. In the embodiment of the present application, the communication apparatus sends a path request to the centralized controller; and the centralized controller establishes the fast transmission path, adds the digital signature of the centralized controller to the fast transmission path, and then forwards the fast transmission path carrying the digital signature to the communication apparatus. In this way, when the communication apparatus sends the data packet carrying the fast transmission path, there is no need to further calculate and find the path by the centralized controller, and the data packet is directly and quickly forwarded based on the fast transmission path carried in the data packet. As such, the in-network forwarding plane device does not need to request the forwarding route from the centralized controller. This greatly reduces the load of the centralized controller, improves the speed at which the forwarding plane device forwards the data packet, and enhances the transmission capability of the network. In addition, since the digital signature of the centralized controller is added to the fast transmission path, after the fast transmission path is verified to be correct based on the digital signature of the centralized controller, and the data packet is forwarded based on the fast transmission path, the fast transmission path is ensured to be correct, communication security of the network is ensured, and hackers are prevented from controlling the network over an unauthorized path.

Referring to FIG. 14, FIG. 14 is a schematic diagram of a centralized controller 700 according to a first embodiment of the present application. The centralized controller 700 includes a first receiving module 701, an establishing module 702 and a sending module 703. The first receiving module 701 is configured to receive a path establishment request from a local communication apparatus, wherein the path establishment request carries identifiers of the local communication apparatus and a peer communication apparatus. The establishing module 702 is configured to establish a fast transmission path between the local communication apparatus and the peer communication apparatus based on the path establishment request. The sending module 703 is configured to send the fast transmission path to the local communication apparatus and the peer communication apparatus, such that the fast transmission path is added to a data packet when the data packet is transmitted between the local communication apparatus and the peer communication apparatus, and one or a plurality of forwarding plane device forwards the data packet based on the fast transmission path carried in the data packet.

Specifically, the sending module 703 includes a first adding unit 7031, a first sending unit 7032, a receiving unit 7033, a second adding unit 7034 and a second sending unit 7035. The first adding unit 7031 is configured to add the first transmission path to the path establishment request. The first sending unit 7035 is configured to forward the path establishment request carrying the first transmission path to the peer communication apparatus. The receiving unit 7033 is configured to receive a response message indicating that the peer communication apparatus agrees to establish the fast transmission path, wherein when the peer communication apparatus sends the first transmission packet to the local communication apparatus, the first transmission path is added to the first transmission packet, such that the in-network forwarding plane device receiving the first transmission packet forwards the first transmission packet based on the first transmission path carried in the first transmission packet. The second adding unit 7034 is configured to add the second transmission path to the response message. The second sending unit 7035 is configured to forward the response message carrying the second transmission path to the local communication apparatus, such that when the local communication apparatus sends the second transmission packet to the peer communication apparatus, the second transmission path is added to the second transmission packet, and the in-network forwarding plane receiving the second transmission packet forwards the second transmission packet based on the second transmission path carried in the second transmission packet.

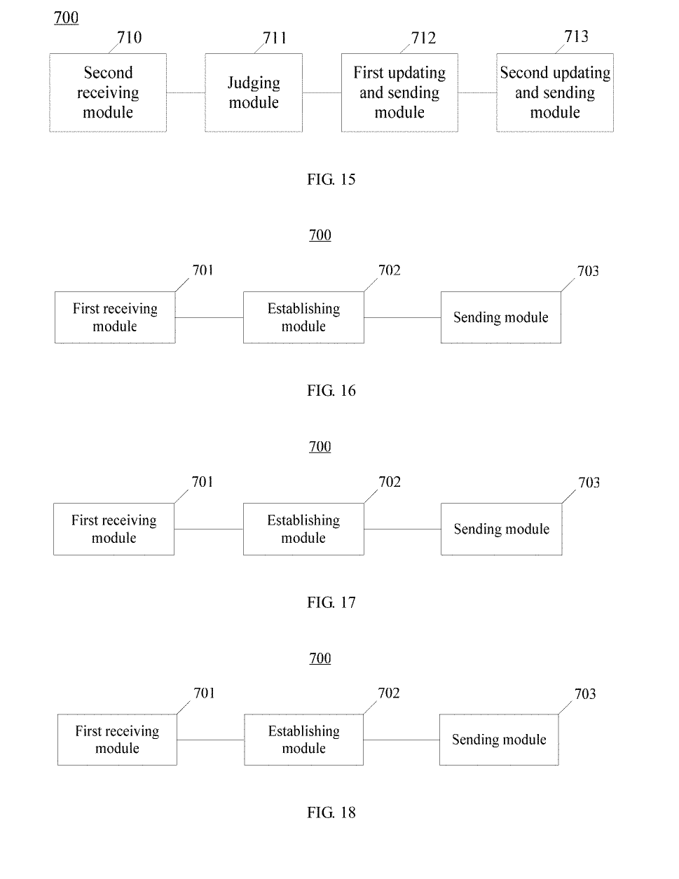

Referring to FIG. 15, FIG. 15 is a schematic diagram of a centralized controller 700 according to a second embodiment of the present application. The centralized controller 700 includes a second receiving module 710, a judging module 711, a first updating and sending module 712 and a second updating and sending module 713. The second receiving module 710 is configured to receive an abnormal message indicating that the in-network forwarding plane device is abnormal, wherein the abnormal message carries an identifier of the abnormal forwarding plane device. The judging module 711 is configured to judge whether the first transmission path and the second transmission path include the abnormal forwarding plane device. The first updating and sending module 712 is configured to update the first transmission path and send the updated first transmission path to the peer communication apparatus if the judging module judges that the first transmission path includes the abnormal forwarding plane device. The second updating and sending module 713 is configured to update the second transmission path and send the updated second transmission path to the peer communication apparatus if the judging module judges that the second transmission path includes the abnormal forwarding plane device.

Referring to FIG. 16, FIG. 16 is a schematic diagram of a centralized controller 700 according to a third embodiment of the present application. The centralized controller 700 includes a first receiving module 701, an establishing module 702 and a sending module 703. The first receiving module 701 is configured to receive a path establishment request from a local communication apparatus, wherein the path establishment request carries identifiers of the local communication apparatus and a peer communication apparatus. The establishing module 702 is configured to establish a fast transmission path between the local communication apparatus and the peer communication apparatus based on the path establishment request. The sending module 703 is configured to send the fast transmission path to the local communication apparatus, such that the fast transmission path is added to a data packet when the local communication apparatus transmits a data packet to the peer communication apparatus, and one or a plurality of forwarding plane device forwards the data packet based on the fast transmission path carried in the data packet.

Referring to FIG. 17, FIG. 17 is a schematic diagram of a centralized controller 700 according to a fourth embodiment of the present application. The centralized controller 700 includes a first receiving module 701, an establishing module 702 and a sending module 703. The first receiving module 701 is configured to receive a path establishment request from a local communication apparatus, wherein the path establishment request carries identifiers of the local communication apparatus and a peer communication apparatus. The establishing module 702 is configured to establish a fast transmission path between the local communication apparatus and the peer communication apparatus based on the path establishment request, and add a digital signature of a centralized controller to the fast transmission path. The sending module 703 is configured to send the fast transmission path carrying the digital signature of the centralized controller to the local communication apparatus and the peer communication apparatus, such that when a data packet is transmitted between the local communication apparatus and the peer communication apparatus and after the fast transmission path is verified to be correct based on the digital signature of the centralized controller, the fast transmission path carrying the digital signature of the centralized controller is added to the data packet, and one or a plurality of forwarding plane device forwards the data packet based on the fast transmission path carried in the data packet after the fast transmission path is verified to be correct based on the digital signature of the centralized controller.

Referring to FIG. 18, FIG. 18 is a schematic diagram of a centralized controller 700 according to a fifth embodiment of the present application. The centralized controller 700 includes a first receiving module 701, an establishing module 702 and a sending module 703. The first receiving module 701 is configured to receive a path establishment request from a local communication apparatus, wherein the path establishment request carries identifiers of the local communication apparatus and a peer communication apparatus. The establishing module 701 is configured to establish a fast transmission path between the local communication apparatus and the peer communication apparatus based on the path establishment request, and add a digital signature of a centralized controller to the fast transmission path. The sending module 703 is configured to send the fast transmission path carrying the digital signature of the centralized controller to the local communication apparatus, such that when a data packet is transmitted between the local communication apparatus and the peer communication apparatus and after the fast transmission path is verified to be correct based on the digital signature of the centralized controller, the fast transmission path carrying the digital signature of the centralized controller is added to the data packet, and one or a plurality of in-network forwarding plane devices forward the data packet based on the fast transmission path carried in the data packet after the fast transmission path is verified to be correct based on the digital signature of the centralized controller.

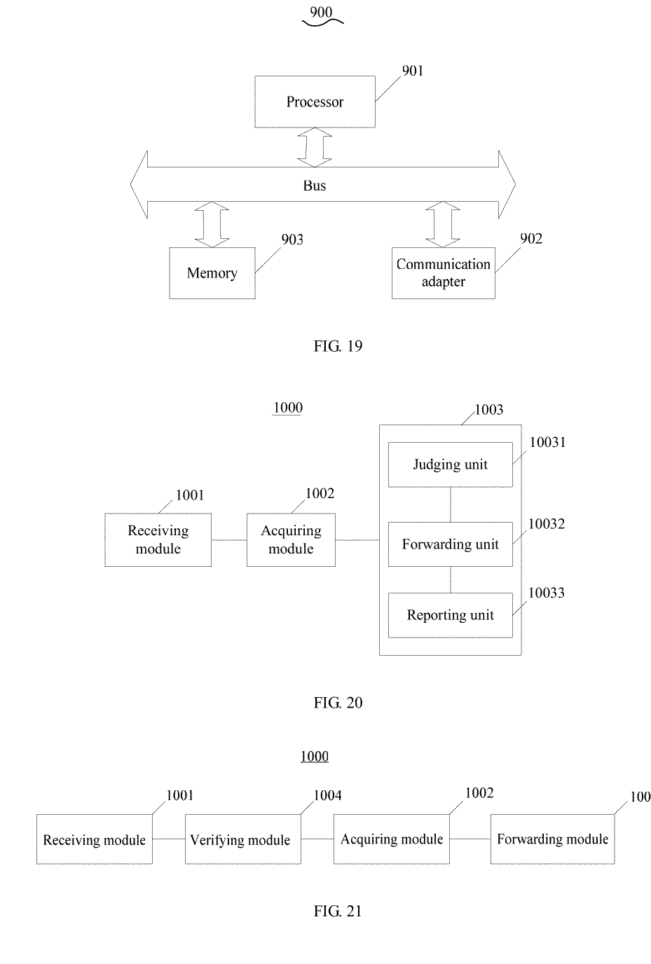

Referring to FIG. 19, FIG. 19 is a schematic diagram of a centralized controller 900 performing a method for data transmitting according to a sixth embodiment of the present application. The centralized controller 900 includes a processor 901, a memory 903, a communication adapter 902 and a bus. The processor 901, the memory 903 and the communication adapter 902 are connected to the bus. In FIG. 15, description is given using connection via a bus.

The memory 903, as a non-volatile computer readable storage medium, may be configured to store non-volatile software programs, non-volatile computer executable programs and modules (the receiving module 701, the establishing module 702, the sending module 703, the second receiving module 710, the judging module 711, the first updating and sending module 712 and the second updating and sending module 713), for example, the program instructions/modules corresponding to the method for data transmitting in the embodiments of the present application. The non-volatile software programs, instructions and modules stored in the memory 903, when being executed, cause the processor 901 to perform various function applications and data processing of a server, that is, performing the method for data transmitting in the above method embodiments. The memory 903 may also include a program storage area and a data storage area. The program storage area may store an operating system and an application implementing at least one function. The data storage area may data created according to use of the apparatus for processing data transmission operations. In addition, the memory 903 may include a high speed random access memory, or include a non-volatile memory, for example, at least one disk storage device, a flash memory device, or another non-volatile solid storage device. In some embodiments, the memory 903 optionally includes memories remotely configured relative to the processor 901.

These memories may be connected to the apparatus for processing item operations over a network. The above examples include, but not limited to, the Internet, Intranet, local area network, mobile communication network and a combination thereof

The at least one module is stored in the memory 903, and when being executed by the at least one processor 901, the at least one module performs the method for data transmitting in any of the above method embodiments.

In this embodiment, a fast transmission path is established between a local communication apparatus and a peer communication apparatus, and transmission paths between the peer communication apparatus and the local communication apparatus are recorded. In this way, during data transmission, there is no need to calculate routing by a centralized controller. Instead, the data is directly and quickly forwarded by a forwarding plane device to a destination, which is favorable to real-time data transmission.

Referring to FIG. 20, FIG. 20 is a schematic diagram of a forwarding plane device 1000 according to a first embodiment of the present application. The forwarding plane device 1000 includes a receiving module 1001, an acquiring module 1002 and a forwarding module 1003. The receiving module 1001 is configured to receive a data packet transmitted in communication between a local communication apparatus and a peer communication apparatus, wherein the data packet carries a fast transmission path for the communication between the local communication apparatus and the peer communication apparatus. The acquiring module 1002 is configured to acquire a next forwarding plane device based on the fast transmission path. The forwarding module 1003 is configured to forward the data packet to the next forwarding plane device.

Specifically, the forwarding module includes a judging unit 10031, a forwarding unit 10032 and a reporting unit 10033. The judging unit 10031 is configured to judge whether the next forwarding plane device is an adjacent forwarding plane device and whether the next forwarding plane device is normally operating. The forwarding unit 10032 is configured to forward the data packet to the next forwarding plane device if the next forwarding plane device is an adjacent forwarding plane device and the next forwarding plane device is normally operating. The reporting unit 10033 is configured to report the data packet to a centralized controller, such that the centralized controller re-performs routing for the data packet.

Referring to FIG. 21, FIG. 21 is a schematic diagram of a forwarding plane device 1000 according to a second embodiment of the present application. The forwarding plane device 1000 includes a receiving module 1001, a verifying module 1004, an acquiring module 1002 and a forwarding module 1003. The receiving module 1001 is configured to receive a data packet transmitted in communication between a local communication apparatus and a peer communication apparatus, wherein the data packet carries a fast transmission path for the communication between the local communication apparatus and the peer communication apparatus, and a digital signature of a centralized controller is added to the fast transmission path. The verifying module 1004 is configured to verify the fast transmission path based on the digital signature of the centralized controller. The acquiring module 1002 is configured to acquiring a next forwarding plane device based on the fast transmission path if the fast transmission path is verified to be correct. The forwarding module 1003 is configured to forward the data packet to the next forwarding plane device.

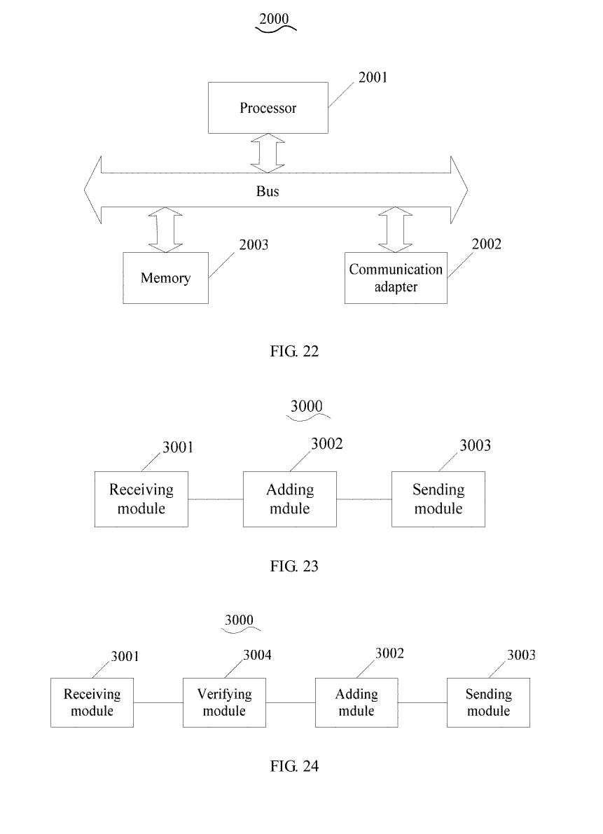

Referring to FIG. 22, FIG. 22 is a schematic diagram of a forwarding plane device 2000 performing a method for data transmitting according to a third embodiment of the present application. The forwarding plane device 2000 includes a processor 2001, a memory 2003, a communication adapter 2002 and a bus. The processor 2001, the memory 2003 and the communication adapter 2002 are connected to the bus. In FIG. 22, description is given using connection via a bus.

The memory 2003, as a non-volatile computer readable storage medium, may be configured to store non-volatile software programs, non-volatile computer executable programs and modules (the receiving module 1001, the acquiring module 1002, the forwarding module 1003 and the verifying module 1004), for example, the program instructions/modules corresponding to the method for data transmitting in the embodiments of the present application. The non-volatile software programs, instructions and modules stored in the memory 2001, when being executed, cause the processor 2003 to perform various function applications and data processing of a server, that is, performing the method for data transmitting in the above method embodiments. The memory 2003 may also include a program storage area and a data storage area. The program storage area may store an operating system and an application implementing at least one function. The data storage area may data created according to use of the apparatus for processing data transmission operations. In addition, the memory 2003 may include a high speed random access memory, or include a non-volatile memory, for example, at least one disk storage device, a flash memory device, or another non-volatile solid storage device. In some embodiments, the memory 2003 optionally includes memories remotely configured relative to the processor 2001. These memories may be connected to the apparatus for processing data transmission over a network. The above examples include, but not limited to, the Internet, Intranet, local area network, mobile communication network and a combination thereof

The at least one module is stored in the memory 2003, and when being executed by the at least one processor 2001, the at least one module performs the method for data transmitting in any of the above method embodiments.

In this embodiment, a fast transmission path is established between a local communication apparatus and a peer communication apparatus. In this way, during data transmission, there is no need to calculate routing by a centralized controller. Instead, the data is directly and quickly forwarded by a forwarding plane device to a destination. If the fast transmission path is abnormal, the abnormal fast transmission path may also be quickly identified and a data packet carrying the abnormal path is re-sent to a centralized controller for further routing calculation, and then a forwarding plane device correctly forwards the data packet to a destination. In this way, data packet loss may be avoided.

Referring to FIG. 23, FIG. 23 is a schematic diagram of a communication apparatus 3000 according to a first embodiment of the present application. The communication apparatus 3000 includes a receiving module 3001, an adding module 3002 and a sending module 3003. The receiving module 3001 is configured to receive a fast transmission path returned from a centralized controller after the fast transmission path is established between the communication apparatus and a peer communication apparatus. The adding module 3002 is configured to add the fast transmission path to a data packet when sending the data packet to the peer communication apparatus. The sending module 3003 is configured to send the data packet carrying the fast transmission path to the peer communication apparatus, wherein one or a plurality of forwarding plane device forwards the data packet based on the fast transmission path carried in the data packet. Optionally, the sending module 3003 includes a selecting unit (not illustrated in FIG. 23) and a forwarding unit (not illustrated in FIG. 23).

The selecting module (not illustrated in FIG. 23) is configured to select a first forwarding plane device based on the fast transmission path.

The forwarding unit (not illustrated in FIG. 23) is configured to send the data packet carrying the fast transmission path to the first forwarding plane device, such that the first forwarding plane device forwards the data packet based on the fast transmission path carried in the data packet, and another in-network forwarding plane device forwards the data packet based on the fast transmission path carried in the data packet.

In the embodiment of the present application, the communication apparatus sends a path request to the centralized controller, and the centralized controller establishes the fast transmission path and sends the established fast transmission path to the communication apparatus. In this way, when the communication apparatus sends the data packet carrying the fast transmission path, there is no need to further calculate and find the path by the centralized controller, and the data packet directly and quickly forwards the data packet based on the fast transmission path carried in the data packet. As such, the in-network forwarding plane device does not need to request the forwarding route from the centralized controller. This greatly reduces the load of the centralized controller, improves the speed at which the forwarding plane device forwards the data packet, and enhances the transmission capability of the network.

Referring to FIG. 24, FIG. 24 is a schematic diagram of a communication apparatus 3000 according to a second embodiment of the present application. The communication apparatus 3000 includes a receiving module 3001, a verifying module 3004, an adding module 3002 and a sending module 3003. The receiving module 3001 is configured to receive a fast transmission path returned from a centralized controller after the fast transmission path is established between the communication apparatus and a peer communication apparatus, wherein a digital signature of a centralized signature is added to the fast transmission path. The verifying module 3004 is configured to verify the fast transmission path based on the digital signature of the centralized controller. The adding module 3002 is configured to add the fast transmission path carrying the digital signature of the centralized controller to a data packet if the fast transmission path is verified to be correct and the communication apparatus needs to send the data packet to the peer communication apparatus. The sending module 3003 is configured to send the data packet carrying the fast transmission path to the peer communication apparatus, wherein one or a plurality of forwarding plane device forwards the data packet based on the fast transmission path upon receiving the data packet and verifying the fast transmission path to be correct based on the digital signature of the centralized controller. Optionally, the sending module 3003 includes a selecting unit (not illustrated in FIG. 24) and a forwarding unit (not illustrated in FIG. 24).

The selecting module (not illustrated in FIG. 24) is configured to select a first forwarding plane device based on the fast transmission path.

The forwarding unit (not illustrated in FIG. 24) is configured to send the data packet carrying the fast transmission path to the first forwarding plane device, such that the first forwarding plane device forwards the data packet based on the fast transmission path carried in the data packet upon receiving the data packet and verifying the fast transmission path to be correct based on the digital signature of the centralized controller, and another in-network forwarding plane device forwards the data packet based on the fast transmission path carried in the data packet upon receiving the data packet and verifying the fast transmission path to be corrected based on the digital signature of the centralized controller.

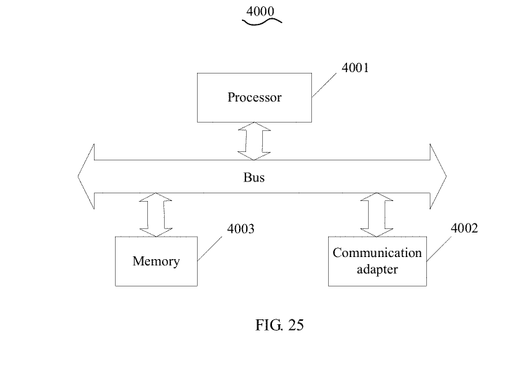

Referring to FIG. 25, FIG. 25 is a schematic diagram of a communication apparatus 4000 performing a method for data transmitting according to a third embodiment of the present application. The communication apparatus 4000 includes a processor 4001, a memory 4003, a communication adapter 4002 and a bus. The processor 4001, the memory 4003 and the communication adapter 4002 are connected to the bus. In FIG. 15, description is given using connection via a bus.

The memory 4003, as a non-volatile computer readable storage medium, may be configured to store non-volatile software programs, non-volatile computer executable programs and modules (the receiving module 3001, the adding module 3002, the sending module 3004 and the verifying module 3004), for example, the program instructions/modules corresponding to the method for data transmitting in the embodiments of the present application. The non-volatile software programs, instructions and modules stored in the memory 4001, when being executed, cause the processor 4003 to perform various function applications and data processing of a server, that is, performing the method for data transmitting in the above method embodiments. The memory 4003 may include a program memory area and data memory area, wherein the program memory area may store operation systems and application programs needed by at least function; and the data memory area may store data created according to the usage of the communication apparatus. In addition, the memory 4003 may include a high speed random access memory, or include a non-volatile memory, for example, at least one disk storage device, a flash memory device, or another non-volatile solid storage device. In some embodiments, the memory 4003 optionally includes memories remotely configured relative to the processor 4001. These memories may be connected to the apparatus for processing data transmission over a network. The above examples include, but not limited to, the Internet, Intranet, local area network, mobile communication network and a combination thereof

In this embodiment, a fast transmission path is established between a communication apparatus and a peer communication apparatus. In this way, during data transmission, there is no need to calculate routing by a centralized controller. Instead, the data is directly and quickly forwarded by a forwarding plane device to a destination. If the fast transmission path is abnormal, the abnormal fast transmission path may also be quickly identified and a data packet carrying the abnormal path is re-sent to a centralized controller for further routing calculation, and then a forwarding plane device correctly forwards the data packet to a destination. In this way, data packet loss may be avoided. The at least one module is stored in the memory 4003, and when being executed by the at least one processor 4001, the at least one module performs the method for data transmitting in any of the above method embodiments.

Described above are exemplary embodiments of the present application, but are not intended to limit the scope of the present application. Any equivalent structure or equivalent process variation made based on the specification and drawings of the present application, which is directly or indirectly applied in other related technical fields, fall within the scope of the present application.

What is claimed is:

1. A method for data transmitting, comprising:
receiving a path establishment request from a local communication apparatus, wherein the path establishment request carries identifiers of the local communication apparatus and a peer communication apparatus;
establishing a fast transmission path between the local communication apparatus and the peer communication apparatus based on the path establishment request; and
sending the fast transmission path to the local communication apparatus and the peer communication apparatus, whereby the fast transmission path is added to a data packet when the data packet is transmitted between the local communication apparatus and the peer communication apparatus, and one or a plurality of in-network forwarding plane devices forward the data packet based on the fast transmission path carried in the data packet.

2. The method according to claim 1, wherein the fast transmission path comprises a first transmission path and a second transmission path, the first transmission path being a path from the peer communication apparatus to the local communication apparatus, and the second transmission path being a path from the local communication apparatus to the peer communication apparatus; and;
the data packet comprises a first transmission packet and a second transmission packet, the first transmission packet being a data packet sent from the peer communication apparatus to the local communication apparatus, and the second transmission packet being a data packet sent from the local communication apparatus to the peer communication apparatus.

3. The method according to claim 2, wherein the sending the fast transmission path to the local communication apparatus and the peer communication apparatus further comprises:
adding the first transmission path to the path establishment request, and forwarding the path establishment request carrying the first transmission path to the peer communication apparatus;
receiving a response message indicating that the peer communication apparatus agrees to establish the fast transmission path;
adding the second transmission path to the response message, and forwarding the response message carrying the second transmission path to the local communication apparatus;
whereby when the peer communication apparatus sends the first transmission packet to the local communication apparatus, the first transmission path is added to the first transmission packet, such that the in-network forwarding plane device receiving the first transmission packet forwards the first transmission packet based on the first transmission path carried in the first transmission packet; and when the local communication apparatus sends the second transmission packet to the peer communication apparatus, the second transmission path is added to the second transmission packet, such that the in-network forwarding plane receiving the second transmission packet forwards the second transmission packet based on the second transmission path carried in the second transmission packet.

4. The method according to claim 2, further comprising:
receiving an abnormal message indicating that the in-network forwarding plane device is abnormal, wherein the abnormal message carries an identifier of the abnormal forwarding plane device;
determining whether the first transmission path and the second transmission path comprise the abnormal forwarding plane device;
updating the first transmission path and sending the updated first transmission path to the peer communication apparatus if the first transmission path comprises the abnormal forwarding plane device; and
updating the second transmission path and sending the updated second transmission path to the local communication apparatus if the second transmission path comprises the abnormal forwarding plane device.

5. The method according to claim 1, further comprising:
adding a digital signature of a centralized controller to the fast transmission path.

6. The method according to claim 5, wherein the sending the fast transmission path to the local communication apparatus and the peer communication apparatus further comprises:
sending the fast transmission path carrying the digital signature of the centralized controller to the local communication apparatus, whereby when the local communication apparatus transmits a data packet to the peer communication apparatus and after the fast transmission path is verified to be correct based on the digital signature of the centralized controller, the fast transmission path carrying the digital signature of the centralized controller is added to the data packet, and one or a plurality of forwarding plane device forwards the data packet based on the fast transmission path after the fast transmission path is verified to be correct based on the digital signature of the centralized controller.

7. The method according to claim 5, wherein the sending the fast transmission path to the local communication apparatus and the peer communication apparatus further comprises:
sending the fast transmission path carrying the digital signature of the centralized controller to the peer communication apparatus, whereby when the peer communication apparatus transmits the data packet and after the fast transmission path is verified to be correct based on the digital signature of the centralized controller, the fast transmission path carrying the digital signature of the centralized controller is added to the data packet, and one or a plurality of forwarding plane device forwards the data packet based on the fast transmission path after the fast transmission path is verified to be correct based on the digital signature of the centralized controller.

8. A method for data transmitting, comprising:
receiving a data packet transmitted in communication between a local communication apparatus and a peer communication apparatus, wherein the data packet carries a fast transmission path of communicating between the local communication apparatus and the peer communication apparatus;
acquiring a next forwarding plane device based on the fast transmission path; and
forwarding the data packet to the next forwarding plane device.

9. The method according to claim 8, wherein prior to the forwarding the data packet to the next forwarding plane device, the method further comprises:
determining whether the next forwarding plane device is an adjacent forwarding plane device and whether the next forwarding plane device is normally operating;
forwarding the data packet to the next forwarding plane device if the next forwarding plane device is an adjacent forwarding plane device and the next forwarding plane device is normally operating; and
otherwise, reporting the data packet to a centralized controller, such that the centralized controller re-performs routing for the data packet.

10. The method according to claim 8, wherein the data packet further carries a digital signature of the centralized controller.

11. The method according to claim 10, further comprising:
verifying the fast transmission path based on the digital signature of the centralized controller;
acquiring the next forwarding plane device based on the fast transmission path if the fast transmission path is verified to be correct; and
forwarding the data packet to the next forwarding plane device.

12. A method for data transmitting, comprising:
receiving a fast transmission path returned from a centralized controller, wherein the fast transmission path is used to establish communication with a peer communication apparatus;
adding the fast transmission path to a data packet when sending the data packet to the peer communication apparatus; and
sending the data packet carrying the fast transmission path to the peer communication apparatus, through one or a plurality of forwarding plane devices determined by the fast transmission path carried in the data packet.

13. The method according to claim 12, wherein prior to the receiving a fast transmission path returned from a centralized controller, the method further comprises:
sending a path establishment request to the centralized controller.

14. The method according to claim 12, wherein a digital signature of a centralized signature is added to the fast transmission path.

15. The method according to claim 14, further comprising:
verifying the fast transmission path based on the digital signature of the centralized controller;
adding the fast transmission path carrying the digital signature of the centralized controller to a data packet if the fast transmission path is verified to be correct;
sending the data packet carrying the fast transmission path to the peer communication apparatus, whereby the in-network forwarding plane device forwards the data packet based on the fast transmission path upon if the fast transmission path is verified to be correct.

16. A method for data transmitting, comprising:
receiving a path establishment request from a communication apparatus, wherein the path establishment request carries identifiers of the communication apparatus and a peer communication apparatus;
establishing a fast transmission path between the communication apparatus and the peer communication apparatus based on the path establishment request; and
sending the fast transmission path to the communication apparatus, whereby the fast transmission path is added to a data packet when the data packet is transmitted between the communication apparatus and the peer communication apparatus, and one or a plurality of in-network forwarding plane devices forward the data packet based on the fast transmission path carried in the data packet.

17. The method according to claim 16, further comprising:
adding a digital signature of a centralized controller to the fast transmission path.
